(19) United States
(12) Patent Application Publication
(10) Pub. No.: US 2025/0330808 A1
(43) Pub. Date: Oct. 23, 2025

(54) METHOD FOR ANNOUNCING AUTHENTICATION AND KEY MANAGEMENT SUITES (AKMS) SUPPORTED BY BASIC SERVICE SETS (BSSS) AFFILIATED WITH AN EXTENDED SERVICE SET (ESS)

(71) Applicant: Cisco Technology, Inc., San Jose, CA (US)

(72) Inventors: Anuj Dharap, Copley, OH (US); Stephen Michael Orr, Wallkill, NY (US); Brian D. Hart, Sunnyvale, CA (US)

(21) Appl. No.: 18/789,125

(22) Filed: Jul. 30, 2024

Related U.S. Application Data
(60) Provisional application No. 63/636,409, filed on Apr. 19, 2024.

(51) Int. Cl. H04W 12/06; H04W 8/22; H04W 12/04

(52) U.S. Cl. CPC H04W 12/06; H04W 8/22; H04W 12/04

(57) ABSTRACT

A method to facilitate roaming in an extended service set (ESS) includes receiving data representative of security capabilities of respective basic service sets affiliated with an extended service set of a wireless local area network, supplying the data representative of security capabilities to respective access points in the respective basic service sets via a distribution network that interconnects respective access points of the respective basic service sets, and sending, from the respective access points, a beacon frame that includes an information element comprising the data representative of the security capabilities of the respective basic service sets affiliated with the extended service set.

This application claims priority to U.S. Provisional Application No. 63/636,409 filed Apr. 19, 2024, the entirety of which is incorporated herein by reference.

### TECHNICAL FIELD

The present disclosure relates to wireless local area network (WLAN) operations, and more particularly to facilitating roaming within an Extended Service Set (ESS) of a WLAN.

### BACKGROUND

A WLAN, implemented in accordance with, e.g., IEEE 802.11 standards, may be comprised of a single Basic Service Set (BSS) or may be comprised of multiple BSSs that are affiliated with an Extended Service Set (ESS). In either case, the process of connecting to the WLAN consists of two separate sub-processes called authentication and association. Authentication employs predetermined keys that may be deployed via Authentication and Key Management suites, or AKMs, hosted by respective Access Points (APs) in the BSS(s).

Currently, there is no methodology to announce the AKMs supported by an ESS within each BSS affiliated with the ESS. This can result in client devices being unable to understand the scope/extent of the AKMs used across a given BSS. This lack of understanding may cause several roaming and other issues.

### BRIEF DESCRIPTION OF THE DRAWINGS

FIG. 1 shows an Extended Service Set (ESS) including AKM Announcement Logic, according to an example embodiment.

FIG. 2 shows an ESS Affiliated AKM suites Information Element, generated, e.g., by AKM Announcement Logic, according to an example embodiment.

FIG. 3 shows an ESS Affiliated RSN (Robust Security Network) Information Element, generated, e.g., by AKM Announcement Logic, according to an example embodiment.

FIG. 4 is a flowchart depicting a series of steps executed by AKM Announcement logic and/or an AP, according to an example embodiment.

FIG. 5 is a block diagram of a computing device that may be configured to host AKM Announcement Logic, and to perform techniques described herein, according to an example embodiment.

### DETAILED DESCRIPTION

### Overview

A method to facilitate roaming in an extended service set (ESS) includes receiving data representative of security capabilities of respective basic service sets affiliated with an extended service set of a wireless local area network, supplying the data representative of security capabilities to respective access points in the respective basic service sets via a distribution network that interconnects respective access points of the respective basic service sets, and sending, from the respective access points, a beacon frame that includes an information element comprising the data representative of the security capabilities of the respective basic service sets affiliated with the extended service set.

A device is also described and includes an interface configured to enable network communications, a memory, and one or more processors coupled to the interface and the memory, and configured to: receive data representative of security capabilities of respective basic service sets affiliated with an extended service set of a wireless local area network, supply the data representative of security capabilities to respective access points in the respective basic service sets via a distribution network that interconnects respective access points of the respective basic service sets, and send, from the respective access points, a beacon frame that includes an information element comprising the data representative of the security capabilities of the respective basic service sets affiliated with the extended service set.

### Example Embodiments

As noted, there is presently no methodology to announce the AKMs supported by an ESS within each BSS affiliated with the ESS. This can result in client devices being unable to understand the scope/extent of the AKMs used across a given BSS. This lack of understanding may cause several roaming and other issues.

For example, a given AP may be operating using WPA3-TM (Wi-Fi Protected Access 3—Transition Mode) in 2.4/5 GHz, but WPA3 (Wi-Fi Protected Access 3) Only in 6 GHz (while using the same authentication methodology). A client device associated on 2.4/5 GHz may get confused regarding the affiliation of the 6 GHz ESS with the 2.4/5 GHz BSS, and vice versa-resulting in unsuccessful roams.

As another example, an AP may be operating multiple BSSID's (Basic Service Set IDs), as part of the same ESS, with different AKM support (while using the same authentication methodology). Client devices currently have no way of understanding the nature of their affiliation, again resulting in roaming issues.

In yet another example, client devices, detecting separate AKMs on a same named SSID (despite being a part of the same ESS), may or may not report the SSIDs as separate entities due to their differing AKMs, despite sharing the same authentication methodology, leading to user confusion, varied field implementations, and potential roaming failures.

As a practical example, according to policy with some manufacturer's client devices, if a given client device first detects WPA3 used with an SSID, the device will not subsequently associate to another AP with lower security (e.g., WPA3-TM) in the same SSID (i.e., same ESS). However, if the given client device first detects WPA3-TM used with an SSID, it may subsequently associate to another AP with the same SSID with the same or higher security (i.e., WPA3-TM or WPA3). This may raise concerns over how that client device might interoperate smoothly in any environment where a single network can be offered by different APs across different floors/buildings/campuses/colleges with a mix of WPA2/WPA3-TM/WPA3 security.

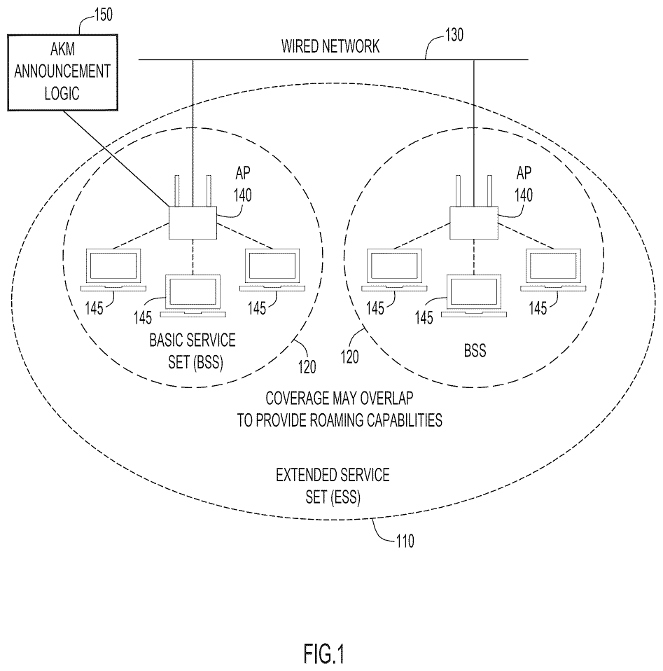

Reference is now made to FIG. 1, which shows an Extended Service Set, or ESS 110, including AKM Announcement Logic 150, according to an example embodiment. ESS 110 comprises two or more Basic Service Sets, or BSSs 120, connected by a common distribution system, such as wired network 130, as shown in the figure. Those skilled in the art will appreciate that the distribution system can be either wired, wireless, LAN, WAN, or any other method of network connectivity. ESS 110 typically has at least two APs 140 operating in infrastructure mode. AKM Announcement Logic 150 may be deployed on one or more APs 140 in the ESS 110, or may be deployed on another platform, but in communication with each of the APs 140, and thus in communication with each BSS 120, in the ESS 110. Client devices 145 access network services via APs 140.

As part of WLAN operations, APs 140 transmit beacons, or beacon management frames (or beacon frames), which organize and synchronize wireless communication within the WLAN. Beacons are used, for example, to synchronize client devices 145 by way of a time-stamp so that client devices 145 can make appropriate changes to their own clocks. The beacon is also used to announce the SSID of the network(s), and client devices 145 can thus, in turn, choose which network to join. Those skilled in the art will appreciate that other information may be provided in beacon frames.

Generally, client devices 145 are configured to passively scan, or listen, for beacons on each channel for a specified period of time after the client device is initialized. As noted, the beacons are transmitted by APs 140. Notably, client devices 145 continue passive scanning even after associating to a given AP 140. Passive scanning saves time reconnecting to the network if a client device 145 is disconnected (disassociated) from an AP 140 to which the client device 145 is currently connected. By maintaining a list of available APs 140 and their characteristics (channel, signal strength, SSID, etc.), the client device 145 can quickly locate the best AP 140 with which to associate should its current connection be broken for any reason.

A given client device 145 will roam from one AP 140 to another after the radio signal from the AP 140 where the station (i.e., client device 145) is connected reaches a predetermined low level of signal strength. Roaming is implemented so that the station can stay connected to the network. Stations use the information obtained through passive scanning for locating the next best AP 140 to use for connectivity back into the network. For this reason, overlap between AP cells is often specified at approximately 20-30%. This overlap allows client devices 145 to seamlessly roam between APs 140 while disconnecting and reconnecting without the user's knowledge.

Embodiments described herein facilitate roaming within ESS 110 by adding an Information Element to beacon frames that are transmitted by APs 140. One of the new Information Elements is referred to as an ESS Affiliated AKM Suites Information Element 200.

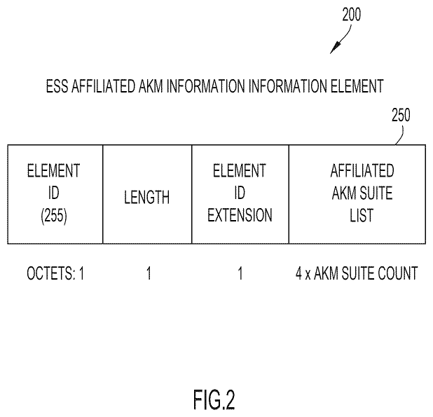

FIG. 2 shows the ESS Affiliated AKM Suites Information Element 200, which is generated, e.g., by AKM Announcement Logic 150, according to an example embodiment. In an embodiment, the ESS Affiliated AKM Suites Information Element 200 may include an Element ID field, a Length field, an Element ID Extension field, and an ESS Affiliated AKM Suite List 250. The number of octets associated with each field is indicated in the figure.

In an embodiment, the Element ID, Length, and Element ID Extension fields are defined, e.g., by IEEE 802.11-2020, Section 9.4.2.1.

An Affiliated ESS AKM Suite Count equals (Length−1)/4 and enumerates the AKM Suites supported within the ESS 110.

In an embodiment, ESS Affiliated AKM Suite List 250 comprises a list of 4-octet AKM suite selectors (as defined, e.g., by IEEE 802.11-2020, Section 9.4.2.24.3 (AKM suites)), and denotes the AKM suites present within the ESS 110. That is, AKM Announcement Logic 150 may be configured identify, for each affiliated BSS 120 in the ESS 110, which AKM suites are being used, and then populate the ESS Affiliated AKM Suites Information Element 200 accordingly. That Information Element is then provided to each AP 140 in the ESS 110 and transmitted in beacon frames, which are received by respective client devices 145 during routine scanning. In an embodiment, AKM Announcement Logic 150 may poll or query each AP 140 for its supported AKMs. Alternatively, or in addition, APs 140 may, as part of their start up procedures, or periodically thereafter, send to AKM Announcement Logic 150 their supported AKMs.

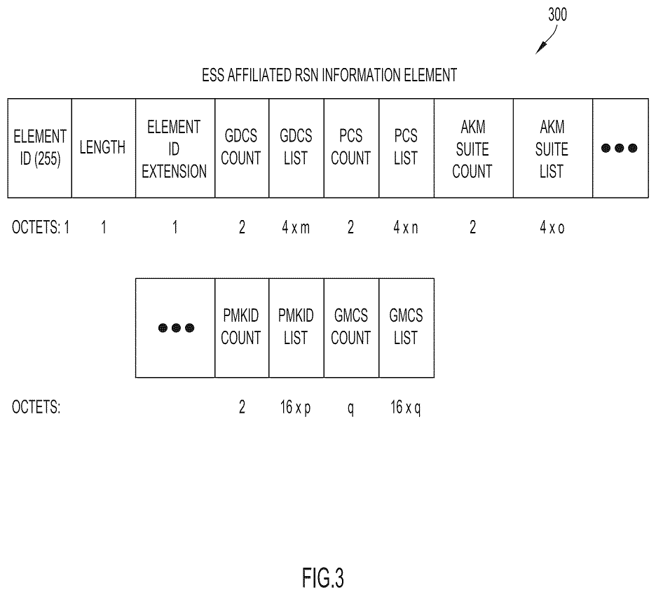

FIG. 3 shows another Information Element referred to as ESS Affiliated RSN (Robust Security Network) Information Element 300, generated, e.g., by AKM Announcement Logic 150, according to an example embodiment.

Specifically, if desired, ESS Affiliated RSN Information Element 300 may be configured to also include any combination of the Group Data Cipher Suites (GDCS), Pairwise Cipher Suites (PCS), PMKIDs, and/or Group Management Cipher Suites present within ESS 110.

ESS Affiliated RSN Information Element 300 may be implemented in a manner (assuming inclusion of all aforementioned fields) similar to what is shown in FIG. 3. The number of octets associated with each field is indicated in the figure. Further details regarding fields indicated in ESS Affiliated RSN Information Element 300 are provided next.

GDCS: Group Data Cipher Suite is defined in, e.g., IEEE 802.11-2020, 9.4.2.24.2.

Group Data Cipher Suite Count (m) enumerates total count of Group Data Cipher Suites supported within ESS 110, with the Group Data Cipher Suite field containing the cipher suite selector(s) used in the ESS 110 to protect group addressed Data frames.

PCS: Pairwise Cipher Suites is defined in, e.g., IEEE 802.11-2020, 9.4.2.24.2.

Pairwise Cipher Suite Count (n) field indicates the number of pairwise cipher suite selectors that are contained in the Pairwise Cipher Suite List field. The Pairwise Cipher Suite List field may contain the series of cipher suite selector(s) that indicate the pairwise cipher suite(s) used in the ESS 110 to protect individually addressed Data frames.

For AKM Suites Fields (AKM Suite Count, AKM Suite List), reference may be made, e.g., to IEEE 802.11-2020, 9.4.2.24.3, as noted previously. The (Affiliated ESS) AKM Suite Count (o) enumerates the AKM Suites supported within the ESS 110. (Affiliated) AKM Suite List comprises a list of 4-octet AKM suite selectors and denotes the AKM Suites present within the ESS 110.

For PMKID (Pairwise Master Key Identifier) fields, reference may be made, e.g., to IEEE 802.11-2020, Section 9.4.2.24.5. The PMKID Count (p) field indicates the number of PMKIDs that are contained in the PMKID List field. The PMKID List field contains a series (possibly empty) of PMKIDS.

GMCS: Group Management Cipher Suites is defined, e.g., in IEEE 802.11-2020, 9.4.2.24.2.

Group Management Cipher Count (q) field may indicate the number of group management cipher suite selectors that are contained in the Group Management Cipher Suite List field. The Group Management Cipher Suite field may contain the cipher suites used within the ESS 110 to protect group addressed robust Management frames.

In the case of FIG. 3, such an Information Element will allow for APs 140 to advertise (via beacon frames) all supported AKMs (and optionally, the Group Data Cipher Suites, Pairwise Cipher Suites, PMKIDs, and/or Group Management Cipher Suites) present within the ESS 110 on every affiliated BSS (sharing the same authentication methodology).

Having AKM Announcement Logic 150 create ESS Affiliated AKM Suites Information Element 200 and/or ESS Affiliated RSN Information Element 300, and thereafter supply the same to APs 140 for broadcast via beacon frames, enables client devices 145 to understand and discern between affiliated networks. The embodiments described herein further allow client devices 145 to better advertise/present to the user—preventing double advertisement of affiliated BSSs sharing authentication methodology but differing on AKM Support. This helps to address potential user confusion and field found issues. For example, there may be situations in which an SSID within a network may have support enabled for multiple AKMs under the same authentication methodology. However, not all APs affiliated to that SSID may support all configured AKMs, leading to situations wherein a client device may see beacons from two different APs broadcasting the same SSID, w/different AKM support. This can be presented to users as a two duplicate SSIDs, leading to user confusion and field failures. Utilizing the approach described herein allows client devices to understand that it is truly just viewing the same SSID—and advertise it correctly to the user as such.

The embodiments described herein still further allow client devices 145 to choose applicable legitimate roaming candidates drawing on information about supported AKMs in ESS 110.

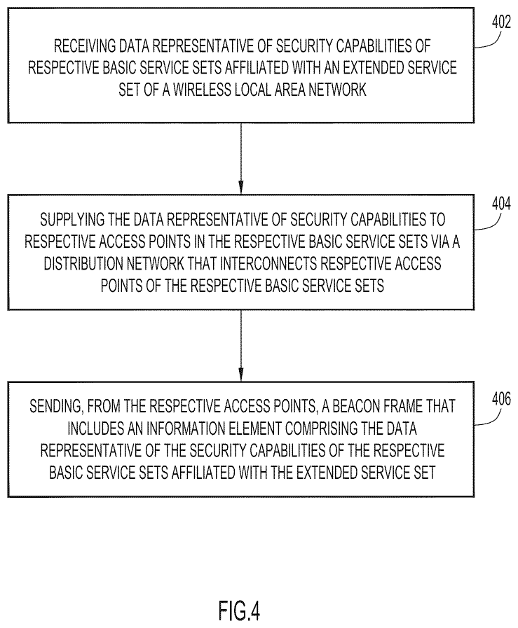

FIG. 4 is a flowchart depicting a series of steps executed by AKM Announcement logic, along with APs 140, according to an example embodiment. At 402, an operation in configured to receive data representative of security capabilities of respective basic service sets affiliated with an extended service set of a wireless local area network. At 404, an operation is configured to supply the data representative of security capabilities to respective access points in the respective basic service sets via a distribution network that interconnects respective access points of the respective basic service sets. And, at 406, an operation is configured to send, from the respective access points, a beacon frame that includes an information element comprising the data representative of the security capabilities of the respective basic service sets affiliated with the extended service set.

In sum, ESS Affiliated AKM Suites Information Element 200 and/or ESS Affiliated RSN Information Element 300 may allow for an advertisement of security capabilities within an ESS to all clients across all affiliated BSSs 120. This can help client devices 145 discern between networks, allowing them to choose applicable roaming candidates when roaming across BSSs 120 sharing authentication methodology but differing on AKM Support. This will also assist client devices 145 in correctly presenting networks to the user, preventing multiple advertisement of affiliated BSSs 120 (sharing authentication methodology, but with different AKM Support).

It is noted that the methodology described herein could also be configured to operate across (or tie together) many ESSs 110 in a given network, by adding an (optional) SSID sub-element, listing SSIDs, in sub-sub-elements in the ESS Affiliated AKM Suites Information Element 200 or ESS Affiliated RSN Information Element 300 transmitted by the beacon frame.

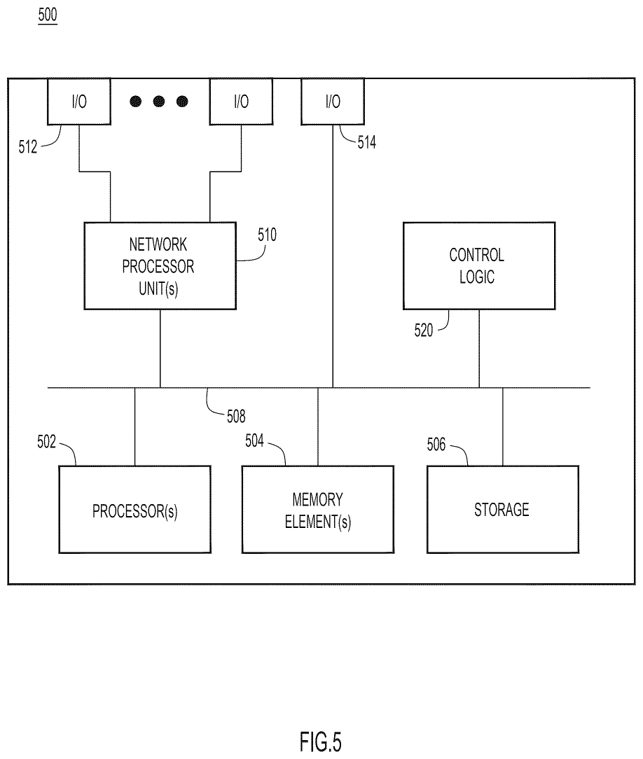

FIG. 5 is a block diagram of a computing device that may be configured to host AKM Announcement Logic, and perform techniques described herein, according to an example embodiment. In various embodiments, a computing device, such as computing device 500 or any combination of computing devices 500, may be configured as any entity/entities as discussed for the techniques depicted in connection with FIGS. 1-4 in order to perform operations of the various techniques discussed herein.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520 (which could include AKM Announcement Logic 150). In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include receiving data representative of security capabilities of respective basic service sets affiliated with an extended service set of a wireless local area network, supplying the data representative of security capabilities to respective access points in the respective basic service sets via a distribution network that interconnects respective access points of the respective basic service sets, and sending, from the respective access points, a beacon frame that includes an information element comprising the data representative of the security capabilities of the respective basic service sets affiliated with the extended service set.

In the method, the information element may include data representing security capabilities within the extended service set across all affiliated basic service sets.

In the method, the data representative of security capabilities may include authentication and key management (AKM) suites supported by the respective basic service sets.

In the method, the information element may include an affiliated AKM suite list field that lists the AKM suites supported by the respective basic service sets.

In the method, the information element may further include data representative of at least one of a Group Data Cipher Suite (GDCS), a Pairwise Cipher Suite (PCS), a Pairwise Master Key Identifier (PMKID), and a Group Management Cipher Suite (GMCS).

In the method, a number of AKM suites that are listed in the information element may be derived from the information element.

The method may further include receiving an authentication request from a client device roaming within the extended service set, based on one of the AKM suites.

In the method, the one of the AKM suites may be a less secure AKM suite than was previously being employed by a client device in a prior authentication with one of the access points.

In the method, at least one of the AKM suites may be compliant with at last one of Wi-Fi Protected Access 2 (WPA2) security, Wi-Fi Protected Access 3—Transition Mode (WPA3-TM) security, Wi-Fi Protected Access 3 (WPA3) security.

The method may further include polling the respective access points for the data representative of the security capabilities of the respective basic service sets.

In another embodiment, a device may be provided and may include an interface configured to enable network communications, a memory, and one or more processors coupled to the interface and the memory, and configured to: receive data representative of security capabilities of respective basic service sets affiliated with an extended service set of a wireless local area network, supply the data representative of security capabilities to respective access points in the respective basic service sets via a distribution network that interconnects respective access points of the respective basic service sets, and send, from the respective access points, a beacon frame that includes an information element comprising the data representative of the security capabilities of the respective basic service sets affiliated with the extended service set.

In the device, the information element may include data representing security capabilities within the extended service set across all affiliated basic service sets.

In the device, the data representative of security capabilities may include authentication and key management (AKM) suites supported by the respective basic service sets.

In the device, the information element may include an affiliated AKM suite list field that lists the AKM suites supported by the respective basic service sets.

In the device, the information element may further include data representative of at least one of a Group Data Cipher Suite (GDCS), a Pairwise Cipher Suite (PCS), a Pairwise Master Key Identifier (PMKID), and a Group Management Cipher Suite (GMCS).

In the device, a number of AKM suites that are listed in the information element may be derived from the information element.

In the device, the one or more processors may be further configured to receive an authentication request from a client device roaming within the extended service set, based on one of the AKM suites.

In yet another embodiment, one or more non-transitory computer readable storage media encoded with instructions are provided and that, when executed by a processor, cause the processor to: receive data representative of security capabilities of respective basic service sets affiliated with an extended service set of a wireless local area network, supply the data representative of security capabilities to respective access points in the respective basic service sets via a distribution network that interconnects respective access points of the respective basic service sets, and send, from the respective access points, a beacon frame that includes an information element comprising the data representative of the security capabilities of the respective basic service sets affiliated with the extended service set.

In the one or more non-transitory computer readable storage media, the information element may include data representing security capabilities within the extended service set across all affiliated basic service sets.

In the one or more non-transitory computer readable storage media, the data representative of security capabilities may include authentication and key management (AKM) suites supported by the respective basic service sets.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
receiving data representative of security capabilities of respective basic service sets affiliated with an extended service set of a wireless local area network;
supplying the data representative of security capabilities to respective access points in the respective basic service sets via a distribution network that interconnects respective access points of the respective basic service sets; and
sending, from the respective access points, a beacon frame that includes an information element comprising the data representative of the security capabilities of the respective basic service sets affiliated with the extended service set.

2. The method of claim 1, wherein the information element comprises data representing security capabilities within the extended service set across all affiliated basic service sets.

3. The method of claim 1, wherein the data representative of security capabilities comprises authentication and key management (AKM) suites supported by the respective basic service sets.

4. The method of claim 3, wherein the information element comprises an affiliated AKM suite list field that lists the AKM suites supported by the respective basic service sets.

5. The method of claim 3, wherein the information element further comprises data representative of at least one of a Group Data Cipher Suite (GDCS), a Pairwise Cipher Suite (PCS), a Pairwise Master Key Identifier (PMKID), and a Group Management Cipher Suite (GMCS).

6. The method of claim 3, wherein a number of AKM suites that are listed in the information element may be derived from the information element.

7. The method of claim 3, further comprising receiving an authentication request from a client device roaming within the extended service set, based on one of the AKM suites.

8. The method of claim 3, wherein the one of the AKM suites is a less secure AKM suite than was previously being employed by a client device in a prior authentication with one of the respective access points.

9. The method of claim 3, wherein at least one of the AKM suites is compliant with at last one of Wi-Fi Protected Access 2 (WPA2) security, Wi-Fi Protected Access 3—Transition Mode (WPA3-TM) security, Wi-Fi Protected Access 3 (WPA3) security.

10. The method of claim 3, further comprising polling the respective access points for the data representative of the security capabilities of the respective basic service sets.

11. A device comprising:
an interface configured to enable network communications;
a memory; and
one or more processors coupled to the interface and the memory, and configured to:
receive data representative of security capabilities of respective basic service sets affiliated with an extended service set of a wireless local area network;
supply the data representative of security capabilities to respective access points in the respective basic service sets via a distribution network that interconnects respective access points of the respective basic service sets; and
send, from the respective access points, a beacon frame that includes an information element comprising the data representative of the security capabilities of the respective basic service sets affiliated with the extended service set.

12. The device of claim 11, wherein the information element comprises data representing security capabilities within the extended service set across all affiliated basic service sets.

13. The device of claim 11, wherein the data representative of security capabilities comprises authentication and key management (AKM) suites supported by the respective basic service sets.

14. The device of claim 13, wherein the information element comprises an affiliated AKM suite list field that lists the AKM suites supported by the respective basic service sets.

15. The device of claim 13, wherein the information element further comprises data representative of at least one of a Group Data Cipher Suite (GDCS), a Pairwise Cipher Suite (PCS), a Pairwise Master Key Identifier (PMKID), and a Group Management Cipher Suite (GMCS).

16. The device of claim 13, wherein a number of AKM suites that are listed in the information element may be derived from the information element.

17. The device of claim 13, wherein the one or more processors are further configured to receive an authentication request from a client device roaming within the extended service set, based on one of the AKM suites.

18. One or more non-transitory computer readable storage media encoded with instructions that, when executed by a processor, cause the processor to:
receive data representative of security capabilities of respective basic service sets affiliated with an extended service set of a wireless local area network;
supply the data representative of security capabilities to respective access points in the respective basic service sets via a distribution network that interconnects respective access points of the respective basic service sets; and
send, from the respective access points, a beacon frame that includes an information element comprising the data representative of the security capabilities of the respective basic service sets affiliated with the extended service set.

19. The one or more non-transitory computer readable storage media of claim 18, wherein the information element comprises data representing security capabilities within the extended service set across all affiliated basic service sets.

20. The one or more non-transitory computer readable storage media of claim 18, wherein the data representative of security capabilities comprises authentication and key management (AKM) suites supported by the respective basic service sets.
